(19) United States
(12) Patent Application Publication
(10) Pub. No.: US 2015/0261297 A1
(43) Pub. Date: Sep. 17, 2015

(54) Tactile Buttons Device For Removable Attachment On A Touch Screen

(71) Applicant: JoyTact Pte Ltd, Singapore (SG)

(72) Inventor: Joo Hai QUEK, Singapore (SG)

(21) Appl. No.: 14/724,822

(22) Filed: May 29, 2015

Related U.S. Application Data
(63) Continuation-in-part of application No. 13/806,847, filed on Dec. 25, 2012.

(30) Foreign Application Priority Data
Oct. 7, 2011 (SG) PCT/SG2011/000350

(51) Int. Cl. G06F 3/01; G06F 3/044; G06F 3/0488; G06F 3/041

(52) U.S. Cl. CPC G06F 3/016; G06F 3/0412; G06F 3/044; G06F 3/0416; G06F 3/04886; G06F 2203/04101; G06F 2203/04803; G06F 2203/04809

(57) ABSTRACT

The present invention provides a tactile buttons device for removable attachment on a capacitive touch screen of an electronic device. The tactile buttons device is made up of a hollow, rigid housing and a plurality of resilient, deformable cones disposed on an upper member of the hollow, rigid housing, with each resilient, deformable cone for supporting a button. A film is disposed across a lower face of the hollow housing to define a lower surface, and a plurality of electrically conducting islands are disposed between the film and the buttons, so that each button is in register with both the associated conducting island and virtual button displayed on the capacitive touch screen. Momentary depressing each of the buttons activates the associated virtual button.

### RELATED PATENT APPLICATIONS

This patent application is a continuation-in-part of U.S. patent application Ser. No. 13/806,847, filed Dec. 25, 2012, which is a National Stage of International Application No. PCT/SG2012/000205, filed Jun. 6, 2012, which claims the benefit of International Application No. PCT/SG2011/000350, filed Oct. 7, 2011.

### FIELD OF THE INVENTION

The present invention relates to a tactile buttons device for removable attachment on a capacitive touch screen of an electronic device. In use, the tactile buttons are placed in register with virtual buttons displayed on the touch screen for operating a program running in the electronic device.

### BACKGROUND

Many electronic devices now have a touch screen 10 for navigating, controlling and/or making an input to operate a software. Such touch screen 10 includes a display screen 12 and a touch sensing system 14 disposed on the display screen. The touch sensing system 14 includes a transparent sensing circuit for allowing a user to operate the software via virtual buttons 16a, 16b, etc. When a user touches a virtual button 16a, 16b, etc, a signal is sent from the touch sensing system to a controller in the electronic device to register an input or selection. For example, the touch sensing system 14 may be a capacitive type; when a user's finger or thumb touches a virtual button 16a, 16b, etc, the touch sensing system senses a capacitance change and the controller then carries out instructions to operate the software running in the electronic device. As a touch screen is flat and smooth, activating a virtual button does not give a tactile feedback to a user; lack of a tactile feedback on a touch screen 10 gives a poor sensory experience, especially to a user for playing a game, say on an iPad or smartphone, when the user can rarely take one's eyes away from the display screen.

To provide a solution, U.S. Publication No. 2011/0157056 by Karpfinger, describes a physical button that provides a tactile feel and a sensed touch on a touch screen. In one embodiment, the button is disposed in a frame. The frame is deformable and when a force on the button is removed, the frame causes the button to revert back to its unactivated position.

U.S. Pat. No. 8,462,133, issued to Apple, Inc., describes a touch sensitive display and a button attachment structure. The button attachment structure includes an attachment area and a button actuation area. The attachment area is mounted on the touch sensitive display so that the button actuation area is aligned over the touch sensitive area. The button attachment area is arranged to deform when a force is applied to the button actuation area to engage the touch sensitive area. The button attachment structure made of silicone rubber is soft, and its edge is susceptible to flip up; in addition, the attachment force is not effective enough to maintain alignment of the button actuation area with the touch sensitive area when operating a gaming software.

It can thus be seen that there exists a need for another removable tactile buttons device for activating virtual buttons on a touch screen of an electronic device.

### SUMMARY

The following presents a simplified summary to provide a basic understanding of the present invention. This summary is not an extensive overview of the invention, and is not intended to identify key features of the invention. Rather, it is to present some of the inventive concepts of this invention in a generalised form as a prelude to the detailed description that is to follow.

The present invention seeks to provide a removable device with depressable, tactile buttons to activate associated virtual buttons displayed on a capacitive touch screen. The tactile buttons device has a tacky contact face for repetitive and removable mounting on the touch screen.

In one embodiment, the present invention provides a tactile buttons device comprising: a hollow, rigid housing with a plurality of apertures formed on an upper member, with the apertures being arranged in a cardinal manner; a resilient, deformable bell-shaped cone is fitted in each of the plurality of apertures from inside the hollow, rigid housing; a button is located in a hole formed through a top of each resilient deformable bell-shaped cone; a film is disposed across a rim of the hollow, rigid housing to form a lower face of the housing; and a plurality of electrically conducting islands disposed on an interior face of the film, so that each electrically conducting island is aligned with an associated button and is in register with a virtual button displayed on the capacitive touch screen, such that momentary depressing a button causes the button to make electrical contact with the associated electrically conducting island, thereby activating the associated virtual button.

Preferably, the resilient deformable bell-shaped cones are integrally formed on a single member. Preferably, the plurality of electrically conducting islands are deposited as films or foils directly on the film, or indirectly on a polymer backing film, which is adhesively attached or laminated on the film.

In one embodiment, the button is dumbbell shaped and comprises an outer flat member, an inner flat member and a neck member connecting the outer and inner flat members. Preferably, an electrically conductive sponge is adhesively attached to the inner flat member of each button; alternatively, an electrically conductive sponge is adhesively attached to each of the electrically conducting islands and in alignment with the associated button.

In other embodiments, kits for assembling the tactile buttons devices of the present invention are provided.

### BRIEF DESCRIPTION OF THE DRAWINGS

This invention will be described by way of non-limiting embodiments of the present invention, with reference to the accompanying drawings, in which:

FIG. 1 illustrates a known set of four directional buttons and another set of four action buttons for a user to operate a program running in an electronic device;

FIGS. 2A and 2B illustrate a tactile buttons device for removable attachment onto a capacitive touch screen according to an embodiment of the present invention;

FIGS. 3A and 3B illustrate the use of electrically conducting islands in the tactile buttons device of the present invention;

FIG. 4A illustrates a plan view of a tactile buttons device according to another embodiment of the present invention, whilst FIG. 4B illustrates a sectional view; and

FIG. 5A illustrates maximizing the centre distances between adjacent buttons of the above tactile buttons device compared with FIG. 5B, which illustrates a device without using the inter-contact member of the present invention.

### DETAILED DESCRIPTION

One or more specific and alternative embodiments of the present invention will now be described with reference to the attached drawings. It shall be apparent to one skilled in the art, however, that this invention may be practised without such specific details. Some of the details may not be described at length so as not to obscure the invention. For ease of reference, common reference numerals or series of numerals will be used throughout the figures when referring to the same or similar features common to the figures.

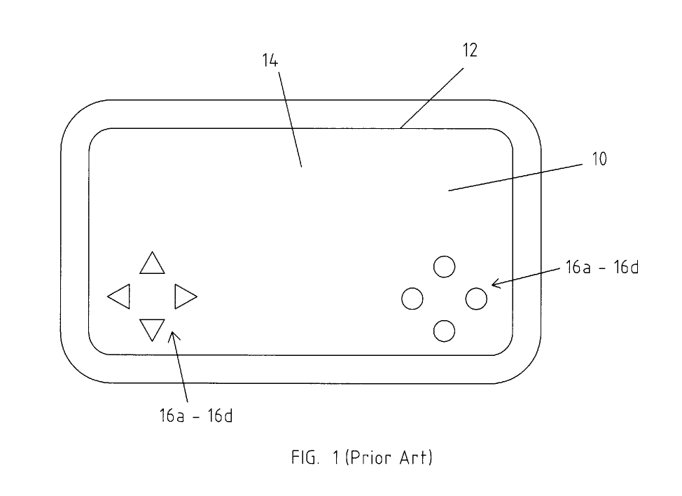

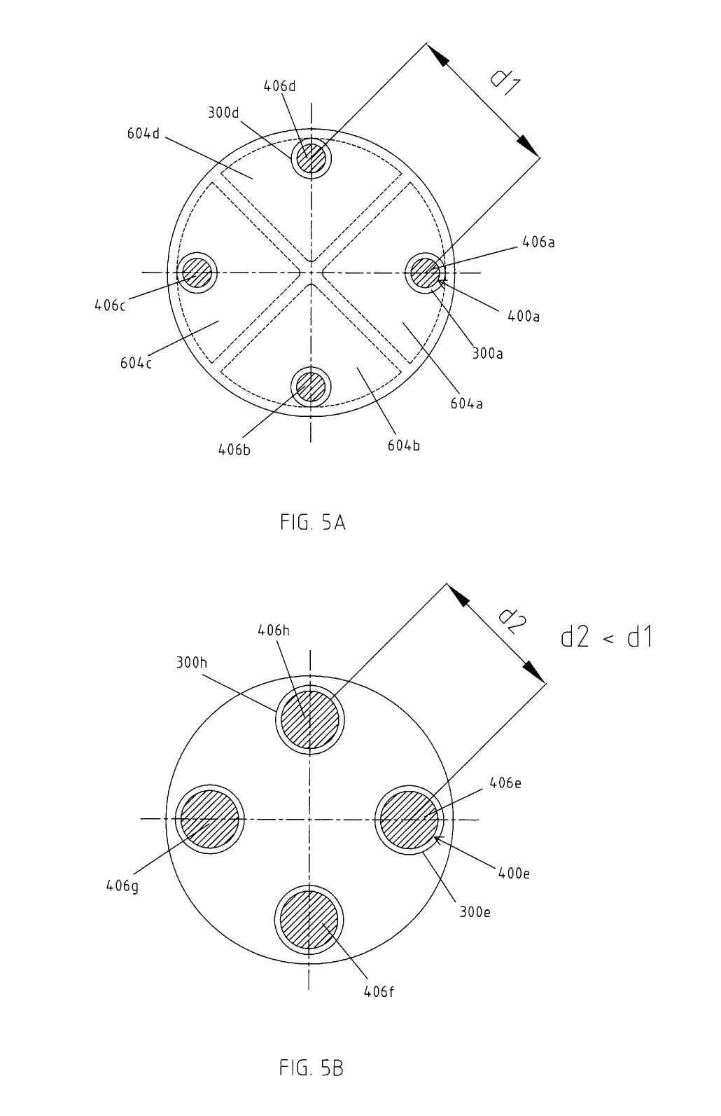

FIG. 1 shows a known touch screen 10 of an electronic device in which a program displays a set of four virtual buttons 16a-16d. Each virtual button must have a minimum predetermined surface area before it can be activated; in other words, the contact area of a finger or thumb on each virtual button must exceed a minimum area on the virtual button before the virtual button can activate; for example, contacting a wire of a paper clip on a virtual button would not activate the virtual button. The minimum contact area on a virtual button also depends on sensitivity of the touch sensing system 14 of the electronic device; the minimum contact area at the virtual buttons will be clearly when FIGS. 5A and 5B are described. Sensitivity of the touch screen is reduced when a screen protector is applied on the touch screen.

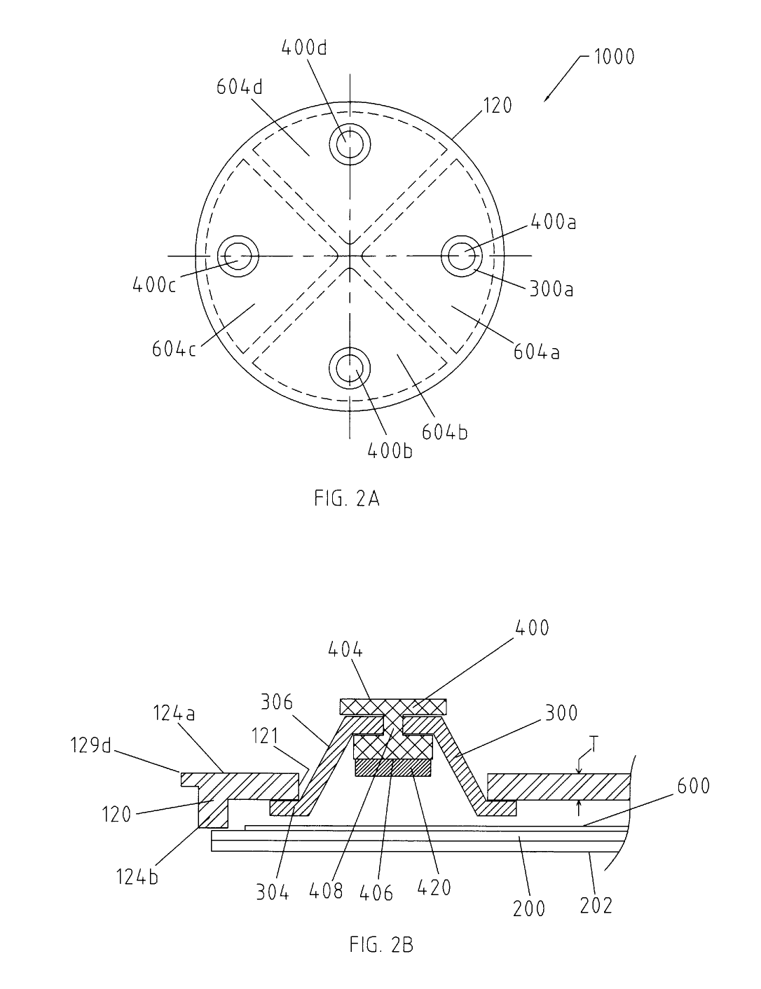

The present invention provides a tactile buttons device 1000 that is removably attachable onto a capacitive touch screen of any electronic device. The tactile buttons device 1000 is exemplified with four buttons 400a-400d. In use, each button 400a-400d on the tactile device 1000 is disposed in register with a corresponding virtual button 16a-16d displayed on the touch screen 10. By depressing the button 400a-400d one at a time, it activates the corresponding virtual button for operating the program running in the electronic device. In one embodiment, as shown in FIG. 2A, the tactile buttons device 1000 is made up of a rigid, hollow housing 120 with the four depressible buttons 400a-400d being disposed on an upper member 124a of the rigid housing 120. A film 200 is disposed across an open, lower rim 124b of the rigid housing 120 and an inter-contact member 600 (with electrically conducting islands 604a-604b) is disposed on an interior face of the film 200. FIG. 2B shows a cross-sectional view of the tactile buttons device 1000. Preferably, the housing 120 and the film 200 are made of transparent materials to allow a user to see the display on the touch screen 10 through the housing 120 and film 200.

As seen in FIGS. 2A and 2B, the housing 120 is substantially hollow but rigid and has a shell thickness T. In one embodiment, the housing 120 has a round outline. It is possible that the outline of the housing 120 is polygonal, star- or gear-shaped, or of other creative shapes. Corresponding to the four depressible buttons, there are four apertures 121 formed on the upper member 124a of the housing 120. The apertures 121 are arranged in a cardinal manner, that is, in a North-South-East-West manner. Each aperture 121 is shaped and sized to receive a resilient, deformable cone 300a-300d, which directly supports an associated depressible button 400a-400d; the resilient, deformable cones 300a-300d therefore give depressing of the buttons 400a-400d a tactile feel. A lower part of the housing 120 is open and the rim 124b extends in a thickness direction of the housing and along the outline of the housing 120 to define a hollow cavity of the housing 120. The film 200 is disposed across the rim 124b to define a lower face of the housing 120. The rigidity of the housing 120 ensures that the tactile buttons device 1000 would not flip up and become displaced or dislodged unintentionally.

In one embodiment, the hollow housing 120 is made of a polymer, glass or ceramic. Preferably, the thickness of the upper member 124a of the hollow housing 120, that is, the part around the central opening 121 is formed with acceptable optical quality so that part of the display on the touch screen 10 seen through the hollow housing 120 is not optically distorted. In other words, the housing 120 does not substantially obstruct or distort the display on the touch screen. Preferably, the housing 120 is made of a clear and transparent polymer, such as polycarbonate, polyester, PE, PET or acrylic. In another embodiment, the housing 120 is made of a coloured, tinted or translucent material. In another embodiment, the housing 120 is made of glass or ceramic; preferably, the glass housing 120 is tempered.

Preferably, the film 200 is attached onto the rim 124b of the hollow housing 120 using an adhesive, such as, an ultraviolet curable clear adhesive. Like transparency of the housing, the film 200 is preferably formed with optical quality. Again “optical quality” means that the film 200 does not adversely distort an image seen through the film 200. On the exterior face of the film 200, with respect to the housing 120, there is a tacky layer 202. The tacky layer 202 allows the tactile buttons device 1000 to be removeably mounted on the touch screen 10 and removed repetitively without leaving any residue. With the substantially the entire exterior face of the film 200 being coated with the tacky material 202, the force of attachment on the touch screen 10 is high, yet allowing the tactile buttons device 1000 to be peeled off from the touch screen without difficulty. Preferably, the force of attachment is high enough to prevent lateral displacement when the housing 120 is subjected to a shear force. Preferably, the upper member 124a is slightly bigger than the rim 124b so as to form a step 129d on the periphery of the housing 120; the peripheral step 129d is provided to allow a user's nail to positively engage a side of the housing 120 for separating or peeling the tactile buttons device 1000 from the touch screen. Preferably, the size of the film 200 is slightly smaller than the rim 124b, so that an adhesive forms a meniscus around a corner formed between the rim 124b and the thickness of the film 200 during manufacturing of the tactile buttons device 1000. Advantageously, the adhesive meniscus formed around the film 200 minimises delamination of the tacky layer 202 from the film 200, thereby giving the tactile buttons device 1000 a long service life.

In one embodiment, the tacky layer 202 is a coating of a silicone adhesive of substantially about 50 micron to about 500 micron in thickness. In another embodiment, the tacky layer 202 is disposed on a backing film, which in turn is laminated onto the film 200. In another embodiment, the tacky layer 202 is a layer of polyurethane adhesive which is coated or laminated on the film 200. The polyurethane tacky layer 202 also has a thickness of substantially about 50 micron to about 500 micron yet thin enough to allow the touch sensing system 14 to operate by sensing a capacitance change as a user's thumb or finger touches the button 400a-400d. In another embodiment, the tacky layer 202 is made of a plasticized polyvinyl chloride (PVC) material. The tacky layer 202 adheres onto the touch screen 10 and allows the tactile buttons device 1000 to be mounted on and removed from the touch screen repetitively without leaving any residue. The adhesive-based tacky layer can adhere onto both smooth and matt screen surfaces. It is sufficient to mention that the tacky layer 202 is different from conventional screen protection film. The conventional screen protection film generally has a very thin adhesive layer of about 30 micron; thus, the screen protection film is not designed to be attached onto and peeled off from the screen surface repetitively. In contrast, the tacky layer 202 of the present invention is durable and washable; after washing, dirt and organic contaminants are removed and the tackiness of the tacky layer 202 is recovered. The film 200 may be made from polycarbonate (PC), polyethylene terephthalate (PET), PE or polyester, whose thickness is substantially 50 micron to about 150 micron. Preferably, the total thickness of the film 200 and the tacky layer 202 is between about 100 micron and 650 micron when the buttons 400a-400d are electrically conductive or electrostatically dissipative (ESD). A total thickness of the film 200 and tacky layer 202 exceeding about 650 micron may reduce sensitivity of the touch sensing system 14.

As seen in FIG. 2B, each resilient, deformable cone 300 is bell-shaped and has a lower flange 304. The side 306 of the cone 300 is conical and this allows the cone to be temporarily deformed when depressed with a finger or thumb. During manufacturing, the lower flange 304 is preferably overmolded to an interior face of the upper member 124a of the housing 120 around each respective aperture 121. Preferably, the resilient, deformable cones 300 are made of a silicone rubber.

In one embodiment of the tactile buttons device 1000, the button 400a-400d is made up of an electrically conductive material or an electrostatically dissipative (ESD) material. Each button 400a-400d is dumbbell shaped, that is, formed with two flat members 404, 406 which are connected by a neck member 408. Preferably, the flat member 404 is disposed above the associated cone 300 and serves as a button for contact with a user's finger or thumb. The neck member 408 is dimensioned to fit around a hole formed through the top of the bell-shaped cone 300 so that the other flat member 406 is disposed inside the bell-shaped cone. In one embodiment, the inside flat member 406 has a smaller surface area than the outer flat member 404 so that the cone 300 is of smaller dimensions and spacing of the buttons 400a-400d are thus maximized to prevent an adjacent button from being unintentionally activated when depressing any one of the buttons 400a-400d.

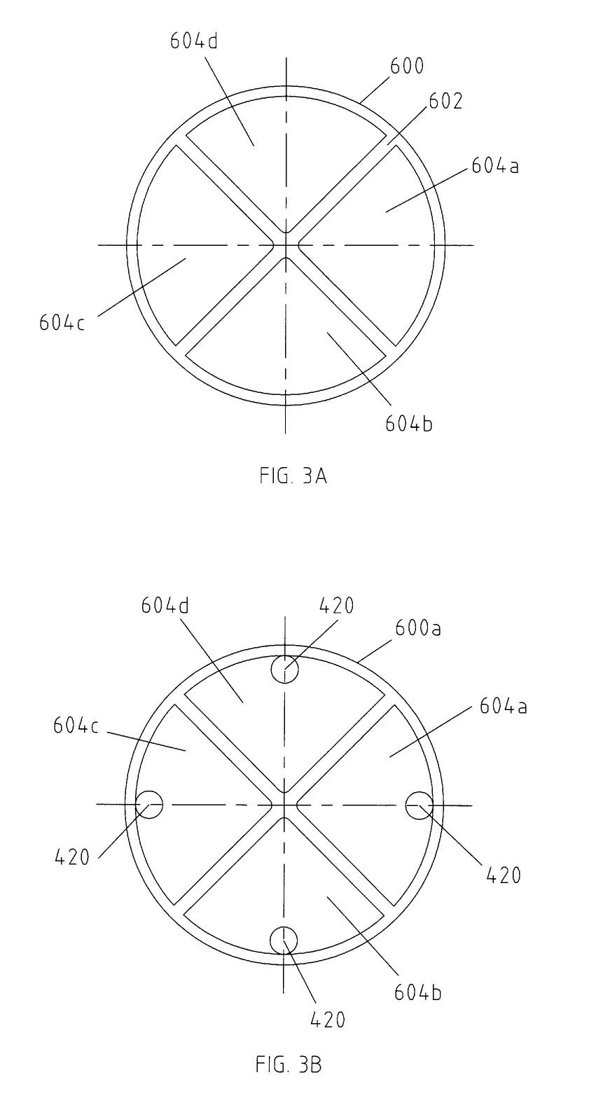

FIG. 3A shows a plan view of the inter-contact member 600. The inter-contact member 600 is made up of a polymer backing 602 with electrically conducting islands 604 deposited on one side. The polymer backing 602 may be of a similar material as the film 200 but preferably thinner so as not to adversely lower the sensitivity of the touch sensing system 14. The number of the electrically conducting islands 604 corresponds to the number of buttons 400a-400d on the tactile buttons device 1000. In use, the inter-contact member 600 is adhesively mounted on the interior face of the film 200 so that each of the conducting islands 604a-604d is aligned for direct contact with each of the buttons 400a-400d. Depressing any one of the buttons 400a-400d causes the associated flat member 406 to contact a corresponding conducting island 604a-604d, thereby allowing the touch sensing system 14 to register a change in capacitance at the associated virtual button 16a-16d on the touch screen 10. Upon releasing of one's finger or thumb from the button, the bell-shaped cone 300 recovers its shape and thus disconnects the flat member 406 from electrical contact with the associated conducting island, resulting in deactivation of the associated virtual button. The present invention thus provides a removable device with tactile buttons for a user to control a software, such as a game, running in the electronic device, to operate a remote controller for internet surfing on a smart television set, and so on. Preferably, the conducting islands 604a-604d are thin, in the range of hundreds of nanometers so that they remain transparent or translucent. Preferably, the conducting islands 604a-604d have electrical surface conductivity of substantially 200 ohm/square unit or less. Preferably, the electrically conducting islands 604a-604d may be made from the following materials: indium tin oxide, nano-carbon, aluminium, gold, platinium, titanium, silver, copper, and similar metal conductors; these electrically conducting materials may be deposited as films using any suitable PVD, CVD or atomic deposition process or as foils.

In another embodiment, the electrically conducting islands 604a-604d are deposited directly or adhesively attached or laminated on the inside face of the film 200; when the electrically conducting islands are deposited directly on the film 200, thickness of the film 200 need not be adjusted to account for the additional thickness of the polymer backing 602 of the inter-contact member 600. Further, to prevent the conducting islands 604a-604d from being damaged by repeated physical contact by the flat member 406 of the button, a conductive sponge or foam 420 may be disposed on the flat member 406. Advantageously, the conductive sponge or foam 420 enhances the tactile feel as each button 400a-400d is depressed. In an alternative embodiment 600a, each of the conductive sponges or foams 420 is adhesively mounted on the associated electrically conducting islands 604a-604d as seen in FIG. 3B.

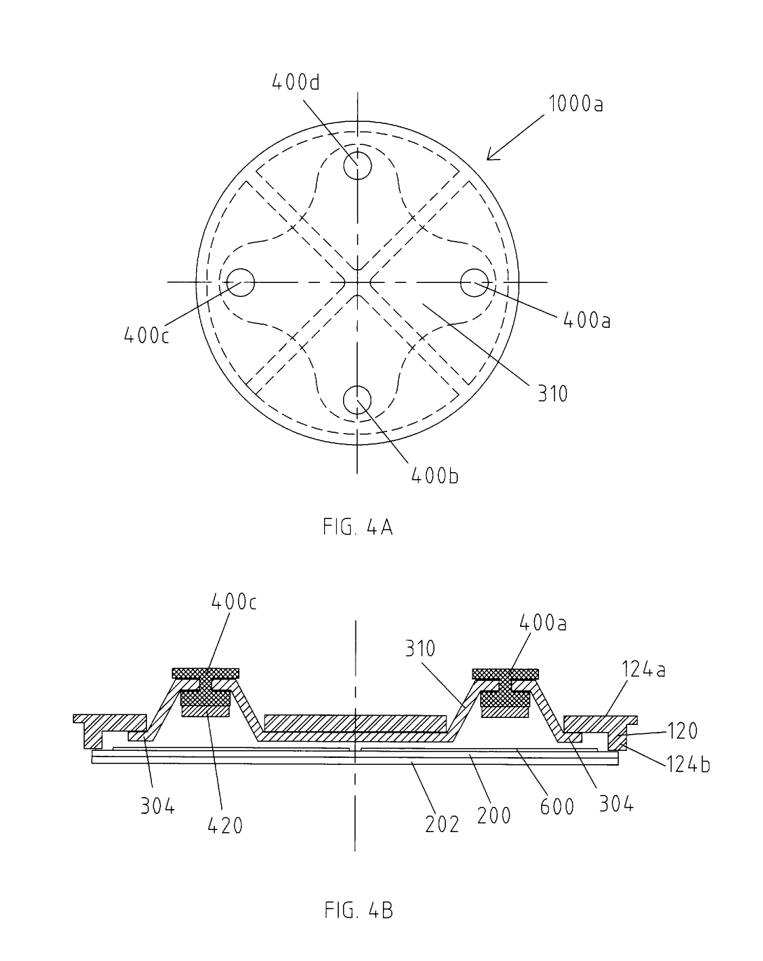

FIG. 4A shows a tactile buttons device 1000a according to another embodiment of the present invention, whilst FIG. 4B shows a sectional view. The tactile buttons device 1000a is similar to the above tactile buttons device 1000 except that the resilient, deformable cones 300 are integrally formed on a single member 310; this singular member 310 is easier to handle during manufacture of the tactile buttons device 1000a. Also, the singular member 310 has a bigger surface area and this provides a larger area for bonding of the singular member 310 onto the interior face of the upper member 124a of the housing 120.

To better illustrate the present invention, when the upper member 124a of the housing is about 25 mm diameter, FIG. 5A shows that the centre-to-centre distance d1 between adjacent buttons 400a-400d is about 11.5 mm when the upper flat member 404 of the button is about 6.5 mm diameter whilst the inside flat member 406 is about 3 mm diameter. In FIG. 5B, when the inter-contact member 600 is absent, the inside flat member 406e-406h has to be increased to about 6 mm diameter for the associated virtual button to activate, but the centre-to-centre distance between adjacent buttons 400e-400h is then reduced to about 10 mm; the reduction of the button centre-to-centre distance is also partly caused by the larger size of the resilient cone 300e-300h required to support the larger flat member 406e-406h of the buttons 400e-400h. With the use of the inter-contact member 600, the centre-to-centre distances between adjacent buttons are optimized and the tactile buttons devices 1000, 1000a of the present invention therefore provide higher degrees of comfort and confidence to a user for activating the correct buttons 400a-400d.

While specific embodiments have been described and illustrated, it is understood that many changes, modifications, variations and combinations thereof could be made to the present invention without departing from the scope of the invention. For example, the upper members 404 of the buttons may be slightly convex or concave; these buttons may be additionally knurled to provide a more positive feel. In the above, four buttons are described; the tactile buttons device is not so limited by the number of buttons; in addition, the layout of the buttons may change according to the layout of the virtual buttons.

1. A tactile buttons device for removable mounting on a capacitive touch screen, the tactile buttons device comprises:
a hollow, rigid housing with a plurality of apertures formed on an upper member, with the apertures being arranged in a cardinal manner;
a resilient bell-shaped cone is fitted in each of the plurality of apertures from inside the hollow, rigid housing;
a button is located in a hole formed through a top of each resilient bell-shaped cone;
a film is disposed across a rim of the hollow, rigid housing to form a lower face of the housing; and
a plurality of electrically conducting islands disposed on an interior face of the film, so that each electrically conducting island is aligned with an associated button and is in register with a virtual button displayed on the capacitive touch screen, such that momentary depressing a button causes the button to make contact with the associated electrically conducting island, thereby activating the associated virtual button.

2. The tactile buttons device according to claim 1, wherein an exterior of the film comprises a tacky layer to allow the tactile buttons device to be repeated mounted on and dismounted from the capacitive touch screen.

3. The tactile buttons device according to claim 1, wherein the resilient bell-shaped cones are integrally formed on a single member.

4. The tactile buttons device according to claim 1, wherein the plurality of electrically conducting islands are deposited on a polymer backing film, with the polymer backing film being adhesively attached or laminated onto the interior face of the film forming the lower face of the housing.

5. The tactile buttons device according to claim 1, wherein the plurality of electrically conducting islands constitute foils that are adhesively attached or laminated onto the interior face of the film forming the lower face of the housing.

6. The tactile buttons device according to claim 1, wherein material of the electrically conducting islands is selected from the following: indium tin oxide, nano-carbon, aluminium, gold, platinium, titanium, silver and copper.

7. The tactile buttons device according to claim 1, wherein the button is dumbbell shaped and comprises an outer flat member, an inner flat member and a neck member connecting the outer and inner flat members.

8. The tactile buttons device according to claim 7, further comprising an electrically conductive sponge being adhesively attached to the inner flat member of each button.

9. The tactile buttons device according to claim 7, further comprising an electrically conductive sponge being adhesively attached to each of the plurality of electrically conducting islands and in register with the inner flat member of each associated button.

10. A kit for assembling a tactile buttons device for use on a capacitive touch screen, the kit comprising:
a hollow, rigid housing formed with a plurality of apertures on an upper member and a rim projecting in a thickness direction around an outline of the hollow, rigid housing, with the apertures being arranged in cardinal directions;
a resilient, deformable bell-shaped cone for fitting in each of the plurality of apertures from inside the hollow, rigid housing;
a button for fitting in a hole formed through a top of each resilient, deformable bell-shaped cone;
a film for attaching across the rim of the hollow, rigid housing, with an interior face of the film having a plurality of electrically conducting islands equal in number as the plurality of apertures and an exterior face of the film is coated with a tacky layer.

11. The kit according to claim 10, wherein the resilient, deformable bell-shaped cones are integrally formed on a single member.

12. The kit according to claim 10, further comprising an electrically conductive sponge for making electrical contact between each button and associated electrically conducting island.

13. A kit for assembling a tactile buttons device for use on a capacitive touch screen, the kit comprising:
a hollow, rigid housing formed with a plurality of apertures on an upper member and a rim projecting downward around an outline of the hollow, rigid housing, with the apertures being arranged in cardinal directions;
a resilient, deformable bell-shaped cone for fitting in each of the plurality of apertures from inside the hollow, rigid housing;
a button for fitting in a hole formed through a top of each resilient, deformable bell-shaped cone;
a film for attaching across the rim of the hollow, rigid housing, with an exterior face of the film being coated with a tacky layer; and
a polymer backing formed with a plurality of electrically conducting islands with the numbers corresponding to an equal plurality of apertures on the hollow, rigid housing so that the polymer backing is disposable on an interior face of the film.

14. The kit according to claim 13, wherein the resilient, deformable bell-shaped cones are integrally formed on a single member.

15. The kit according to claim 13, further comprising an electrically conductive sponge for making electrical contact between each button and associated electrically conducting island.
